(19) United States
(12) Patent Application Publication
(10) Pub. No.: US 2002/0086081 A1
(43) Pub. Date: Jul. 4, 2002

(54) Device for making lipstick

(76) Inventor: Fu Chin Kuo, Tainai Hsien (TW)

Correspondence Address: CHARLES E. BAXLEY, 59 John Street-5th Floor, New York, NY, 10038, US

(21) Appl. No.: 09/751,819

(22) Filed: Jan. 2, 2001

(51) Int. Cl. B29C 39/36

(52) U.S. Cl. 425/440; 425/DIG. 44

(57) ABSTRACT

A lipstick making device includes a mold piece having one or more mold cavities for receiving a lipstick material, and one or more reinforcing plates engaged in the mold piece and each having one or more ears that are preferably extended from the ends of the plates. One or more rods are engaged through the ears of the plate for stably moving the plate in a direction radially away from the mold piece to uniformly expand the mold piece. One or more actuators are attached to one or more of the rods for expanding the mold piece with the rods.

### BACKGROUND OF THE INVENTION

1. Field of the Invention

The present invention relates to a device, and more particularly to a device for making a lipstick.

2. Description of the Prior Art

The closest prior art of which the applicant is aware is his prior US Pat. No. 6,022,209 to Kuo and comprises one or more actuators coupled to one or more mold pieces for expanding the mold pieces and for facilitating the removing of the lipsticks from the mold pieces. The mold pieces are normally made of rubber or plastic materials and may be easily damaged after being expanded for several times.

U.S. Pat. No. 3,947,209 to Fox discloses a mechanical expander having a number of spaced metal plates engaged in the elastic candle mold for expanding the elastic candle mold. However, the metal plates each includes a radial projection extended from the middle or center portion thereof and extended outward of the elastic candle mold and coupled to pulling rods. The pulling rods are coupled to the middle or the center portion of the metal plate and are directed inward of the elastic mold piece, such that the metal plates may not be stably moved or pulled radially outward to expand the elastic mold piece. For example, the metal plates may have only the lower portion pulled radially outward of the elastic mold piece, such that the upper portion of the mold piece may not be expanded and such that the lipstick may not be easily disengaged from the elastic mold piece. The elastic candle mold will also be easily damaged after being expanded for several times. The metal plates may be moved relative to the elastic candle mold and may also have a great chance to be pulled outward of the elastic candle mold after use.

The present invention has arisen to mitigate and/or obviate the afore-described disadvantages of the conventional lipstick making devices.

### SUMMARY OF THE INVENTION

The primary objective of the present invention is to provide a device for making lipsticks having one or more reinforcing plates engaged in the elastic mold piece for solidly expanding the elastic mold piece and for preventing the elastic mold piece from being damaged by frequent expanding operations.

In accordance with one aspect of the invention, there is provided a lipstick making device comprising a mold piece including at least one mold cavity formed therein for receiving a lipstick material, at least one reinforcing plate engaged in the mold piece, the reinforcing plate including two ends each having an ear extended outward therefrom, and at least one rod engaged through the ears of the reinforcing plate for moving the reinforcing plate in a direction radially away from the mold piece and for expanding the mold piece to disengage and to remove the lipstick material from the mold piece.

The rods each includes a base, the moving means includes at least one actuator attached to at least one of the rods for expanding the mold piece with the rods.

The mold piece includes at least two ribs laterally extended outward therefrom and spaced from each other, the rods are engaged through the ribs of the mold piece respectively.

A seat is further provided and disposed on top of the mold piece and includes an opening formed therein and aligned with the mold cavity of the mold piece for receiving the lipstick material and for forming a root portion of the lipstick material.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a lipstick making device in accordance with the present invention;

FIG. 2 is a perspective view of the device, in which one half of the device is cut off;

FIG. 3 is a perspective view of the reinforcing plate;

FIG. 4 is a cross sectional view taken along lines 4-4 of FIG. 5;

FIG. 5 is a cross sectional view taken along lines 5-5 of FIG. 4;

FIG. 6 is a cross sectional view taken along lines 6-6 of FIG. 7; and

FIG. 7 is a cross sectional view taken along lines 7-7 of FIG. 6.

### DETAILED DESCRIPTION OF THE PREFERRED EMBODIMENT

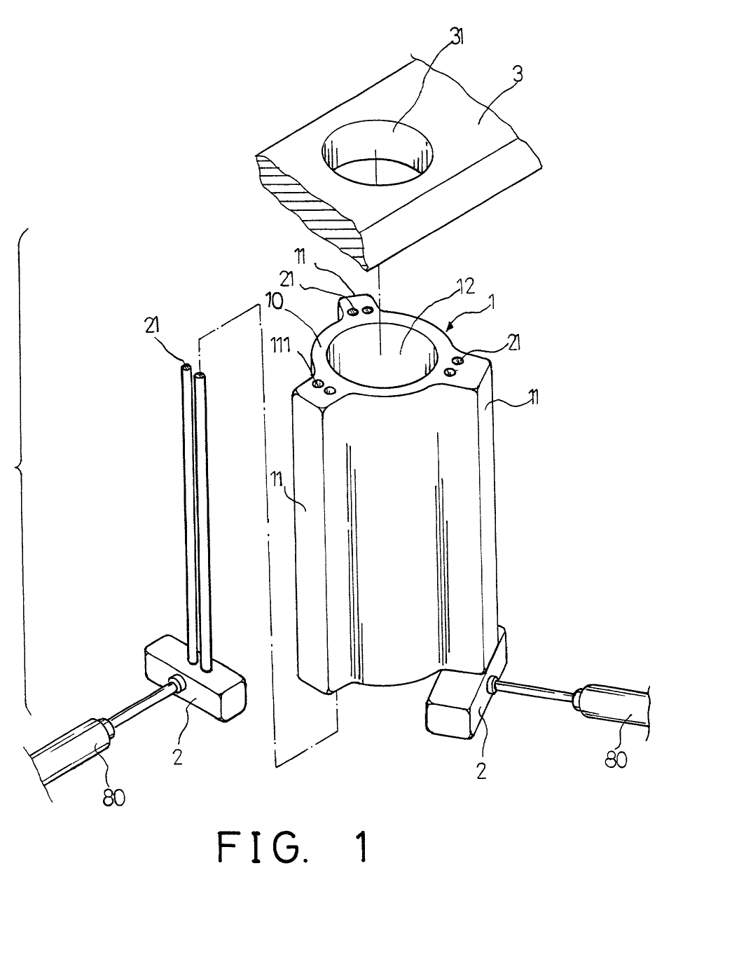

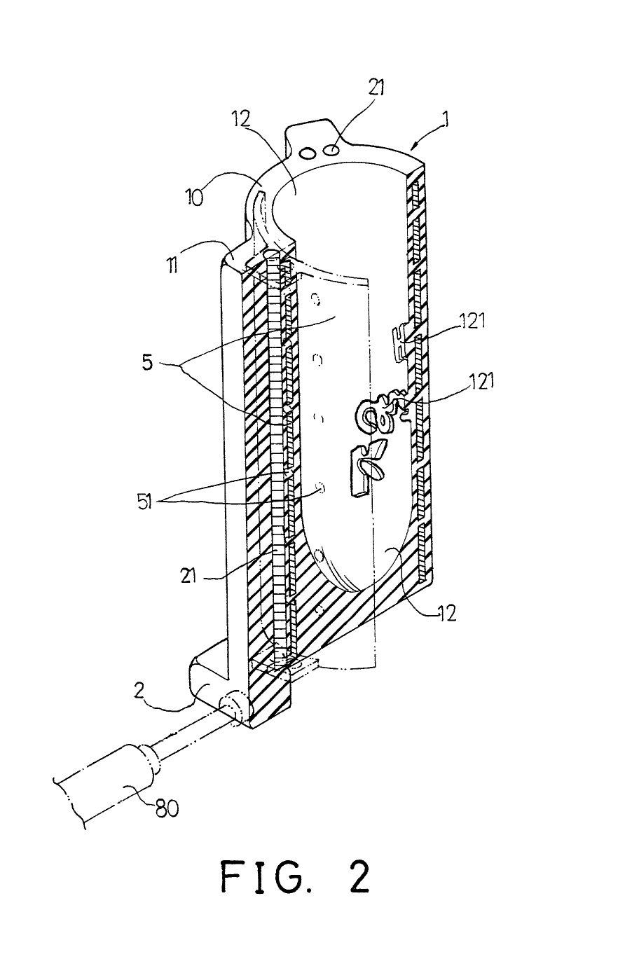

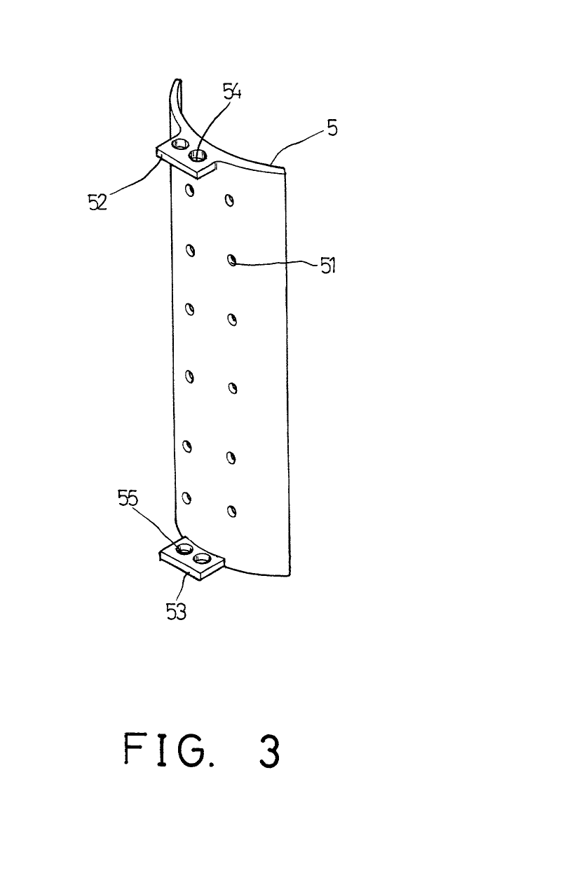

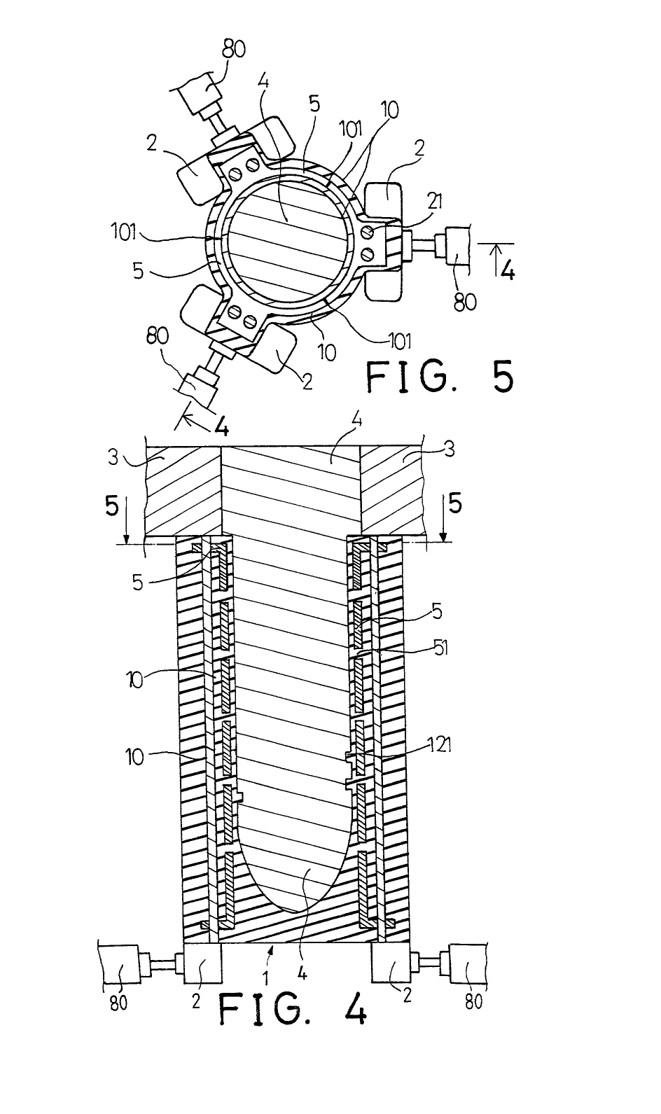

Referring to the drawings, and initially to FIGS. 1-5, a lipstick making device in accordance with the present invention comprises a mold piece 1 having a mold cavity 12 formed therein for receiving the lipstick material 4. The mold piece 1 is made of elastic rubber or plastic materials and is preferably formed as a cylindrical shape having three or more longitudinal ribs 11 laterally extended outward therefrom and angularly spaced from each other. The ribs 11 each includes one or more orifices 111 formed therein. Three or more bases 2 each includes one or more rods 21 extended upward therefrom and engaged through the orifices 111 of the ribs 11. The mold piece 1 includes one or more letters or includes a pattern 121 provided therein and extended inward of the mold cavity 12 of the mold piece 1 for forming the corresponding patterns in the outer peripheral portion of the lipstick material 4 after the lipstick material 4 is cured or formed.

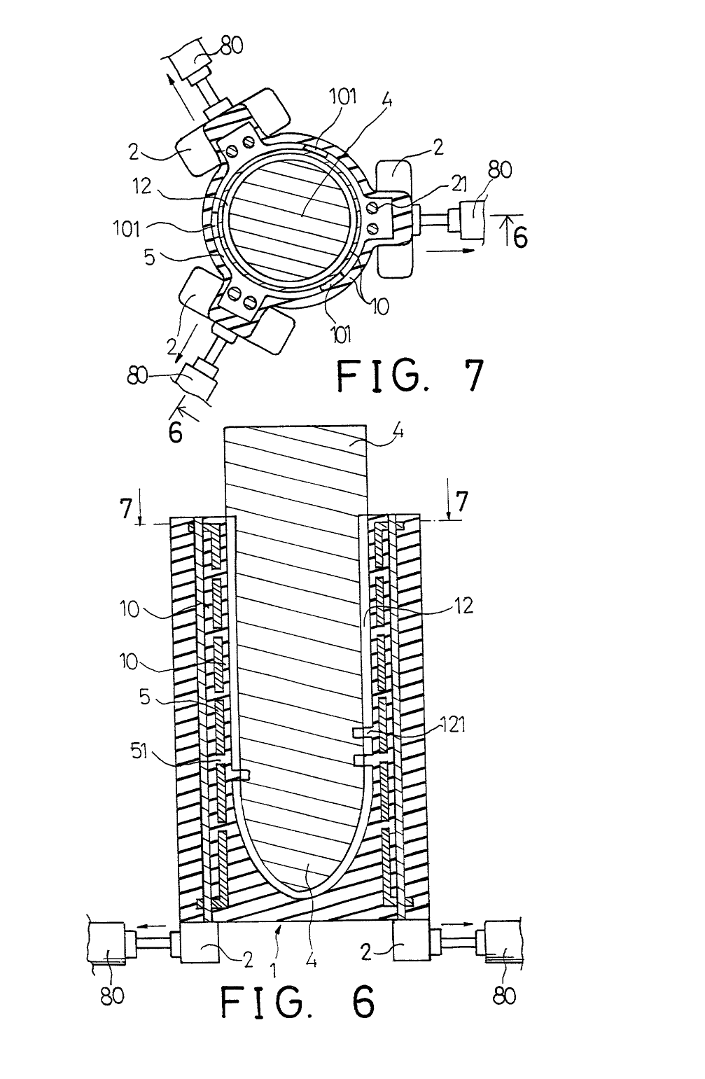

One or more actuators 80, such as the hydraulic cylinders or pneumatic cylinders, are secured to the bases 2 for moving the bases 2 and the rods 21 radially outward of or away from the mold piece 1 and for expanding the mold piece 1 (FIGS. 6, 7) such that the lipstick material 4 may be easily removed and disengaged from the mold piece 1 without damaging the pattern 42, 43 of the lipstick material 4. It is preferable that a seat 3 is disposed on top of the mold piece 1 and has an opening 31 formed therein and aligned with the mold cavity 12 of the mold piece 1 for forming the root portion of the lipstick material 4 and for removing the lipstick material 4 out of the mold piece 1 after the lipstick material 4 is cured.

The elastic materials for forming the mold piece 1 are elastic or resilient and are heat-resistive and include the synthetic plastic materials, polymer materials, or glutinous materials, that may be expanded and deformed. The pattern may also be provided in a small area or in a portion of the outer peripheral surface of the lipstick material 4, such that the lipstick material 4 may probably be disengaged from the mold piece 1 by moving only one or two of the bases 2 and the rods 21. It is also to be noted that the mold piece 1 may also include two or more mold cavities 12 formed therein for simultaneously forming two or more lipstick materials 4 having a pattern 42, 43 formed therein. The above described structure is typical and has been disclosed in the applicant's prior U.S. Pat. No. 6,022,209 which is taken as a reference for the present invention.

The device in accordance with the present invention further includes one or more, such as two or three or more reinforcing plates 5 engaged in the elastic mold piece 1. The plates 5 each includes one or more ears 52, 53 extended outward therefrom, such as extended outward from the upper portion and/or the lower portion of the plate 5. The ears 52, 53 each includes one or more apertures 54, 55 formed therein for receiving the rods 21 (FIGS. 6, 7). The rods 21 are not directed inward of the elastic mold piece 1 and are parallel to the elastic mold piece 1. In addition, the ears 52, 53 are preferably extended outward from the upper portion and/or the lower portion of the plate 5 such that the reinforcing plates 5 may be effectively moved radially outward to expand the elastic mold piece 1, for allowing the lipstick material 4 to be easily disengaged from the mold piece 1. The plates 5 thus may be used to effectively expand the mold piece 1.

The plates 5 are preferably made of plastic or metal materials, such as steel or alloy materials, that have a stiffness for preventing the plates 5 from being easily bent or distorted. The plates 5 each preferably includes one or more holes 51 formed therein, and are engaged in the mold piece 1 with such as a mold injection or mold ejecting process, or with the other molding processes. The material for forming the mold piece 1 may be engaged into the holes 51 of the plates 5 for allowing the plates 5 to be solidly engaged in the mold piece 1.

Accordingly, the device in accordance with the present invention includes one or more reinforcing plates engaged in the elastic mold piece for solidly expanding the elastic mold piece and for preventing the elastic mold piece from being damaged by frequent expanding operations.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A lipstick making device comprising:
a mold piece including at least one mold cavity formed therein for receiving a lipstick material,
at least one reinforcing plate engaged in said mold piece, and
at least one rod engaged through said mold piece and parallel to said mold piece and coupled to said at least one reinforcing plate for moving said at least one reinforcing plate in a direction radially away from said mold piece and for expanding said mold piece to disengage and to remove the lipstick material from said mold piece.

2. The lipstick making device according to claim 1, wherein said at least one reinforcing plate includes an upper end having an ear extended outward therefrom, said ear includes at least one aperture formed therein for receiving said at least one rod.

3. The lipstick making device according to claim 1, wherein said at least one reinforcing plate includes a lower end having an ear extended outward therefrom, said ear includes at least one aperture formed therein for receiving said at least one rod.

4. The lipstick making device according to claim 1, wherein said at least one reinforcing plate includes at least one hole formed therein, said mold piece includes a material engaged through said at least one hole of said at least one reinforcing plate for solidly retaining said at least one reinforcing plate in said mold piece.

5. A lipstick making device comprising:
a mold piece including at least one mold cavity formed therein for receiving a lipstick material,
at least one reinforcing plate engaged in said mold piece, said at least one reinforcing plate including two ends each having an ear extended outward therefrom, and
at least one rod engaged through said ears of said at least one reinforcing plate for moving said at least one reinforcing plate in a direction radially away from said mold piece and for expanding said mold piece to disengage and to remove the lipstick material from said mold piece.

6. A lipstick making device comprising:
a mold piece including at least one mold cavity formed therein for receiving a lipstick material,
at least two reinforcing plates engaged in said mold piece, said at least two reinforcing plates each including two ends each having an ear extended outward therefrom,
at least two rods engaged through said ears of said at least two reinforcing plates for moving said at least one reinforcing plates in a direction radially away from said mold piece and for expanding said mold piece to disengage and to remove the lipstick material from said mold piece, and
means for moving at least one of said at least two rods in the direction radially away from said mold piece to expand said mold piece.

7. The lipstick making device according to claim 6, wherein said at least two rods each includes a base, said moving means includes at least one actuator attached to at least one of said at least two rods for expanding said at least one of said at least two rods.

8. The lipstick making device according to claim 6, wherein said mold piece includes at least two ribs laterally extended outward therefrom and spaced from each other, said at least two rods are engaged through said at least two ribs of said mold piece respectively.

9. The lipstick making device according to claim 6 further comprising a seat disposed on top of said mold piece and including an opening formed therein and aligned with said mold cavity of said mold piece for receiving the lipstick material and for forming a root portion of the lipstick material.

10. The lipstick making device according to claim 6, wherein said at least two reinforcing plates each includes at least one hole formed therein, said mold piece includes a material engaged through said at least one holes of said at least two reinforcing plates.
